(19) United States
(12) Patent Application Publication
(10) Pub. No.: US 2012/0118871 A1
(43) Pub. Date: May 17, 2012

(54) HEATING STRUCTURE

(76) Inventors: Chi-Sheng HUANG, Lugang Township (TW); Li-Gung Lai, Changhua City (TW)

(21) Appl. No.: 12/945,322

(22) Filed: Nov. 12, 2010

(51) Int. Cl. H05B 3/02

(52) U.S. Cl. 219/538

(57) ABSTRACT

A heating structure includes at least a substrate, a carbon-material film layer which is coated on a surface of the substrate and two electrodes which are provided at two sides of the carbon-material film layer. A surface of the substrate that is coated with the carbon-material film layer is a rough surface to increase a heat transfer area between the substrate and the carbon-material film layer, thereby improving a heat transfer efficiency and at a same time, increasing an adhesive force between the carbon-material film layer and the substrate to prevent the carbon-material film layer from dropping out.

### BACKGROUND OF THE INVENTION

a) Field of the Invention

The present invention relates to a heating structure and more particularly to a heating structure which is characterized in that a rough surface is formed on a glass surface to increase a heat transfer area and prevent a carbon-material film layer from dropping out.

b) Description of the Prior Art

An existing thermoelectric product will normally utilize a resistance wire or a thermoelectric tube to generate heat energy for a purpose of heating up an object. However, as the resistance wire and the thermoelectric tube cannot produce heat on a larger and uniform surface, a thermoelectric efficiency is low, which results in consumption of energy.

To solve the aforementioned shortcoming, a film heating structure is developed, utilizing a vacuum sputtered metal film on a glass tube, a glass plate or a quartz tube as a medium of electricity conduction. Referring to FIG. 1 and FIG. 2, with FIG. 1 showing a structural schematic view of a conventional tube-shaped metal film heating structure and FIG. 2 showing a structural schematic view of a conventional plate-shaped metal film heating structure, the heating structure 10, 20 as shown in FIG. 1 and FIG. 2 includes primarily a substrate 11, 21, wherein a surface of the said substrate 11, 21 is coated with a metal film layer 12, 22 by the vacuum sputtering method and the film layer 12, 22 is provided with two electrodes 13a, 13b and 23a, 23b. When a power source is connected to the two electrodes 13a, 13b or 23a, 23b, a heating effect is achieved by generating heat from the metal film layer 12, 22. However, this kind of heating structure 10, 20 is not perfect as the large metal film layer 12, 22 is provided with a high processing cost. Therefore, a heating structure using carbon as a conductive film layer arises, as shown in FIG. 3 and FIG. 4, wherein FIG. 3 shows a structural schematic view of a tube-shaped carbon-material film heating structure and FIG. 4 shows a structural schematic view of a plate-shaped carbon-material film heating structure. In the said heating structure 30, 40, a carbon material is sprayed directly on a substrate 31, 41 of a glass tube or a glass plate as a conductive film layer 32, 42, and then an insulation layer 33, 43 is provided on the conductive film layer 32, 42 to prevent the conductive film layer 32, 42 from dropping out. Nevertheless, as the substrate of the glass tube or the glass plate is provided with a smooth surface, the film layer 32, 42 can drop out easily.

In addition, to overcome the abovementioned issue of the drop-out of the carbon-material film layer, a structure as shown in FIG. 5 and FIG. 6 is developed, wherein FIG. 5 shows a structural schematic view of a tube-shaped carbon-material film heating structure and FIG. 6 shows a structural schematic view of a plate-shaped carbon-material film heating structure; whereas, in the heating structure 50, 60 as shown in FIG. 5 and FIG. 6, a bonding layer 53, 63 is provided between a smooth surface of substrate 51, 61 of a glass tube or a glass plate and a carbon-material film layer 52, 62 to increase an adhesive force between the carbon-material film layer 52, 62 and the substrate 51, 61, thereby overcoming the phenomenon of dropping out. Yet, this kind of structure results in a loss of heat transfer and therefore, can be only used on a component of low heat transfer efficiency.

### SUMMARY OF THE INVENTION

To solve the abovementioned shortcomings of prior arts, the present invention provides a heating structure with the primary object of providing a high efficiency heating structure by which a heat transfer area is increased and drop-out of a carbon-material film layer can be avoided.

The technical means used by the present invention is to provide a heating structure which includes a substrate, a carbon-material film layer coated on a surface of the substrate and two electrodes provided at two sides of the carbon-material film layer, wherein an outer surface of the substrate that is coated with the carbon-material film layer is a rough surface to increase a heat transfer area between the substrate and the carbon-material film layer, thereby improving the heat transfer efficiency. In a same time, the adhesive force between the carbon-material film layer and the substrate can be increased to prevent the carbon-material film layer from dropping out.

In the abovementioned heating structure, according to the present invention, the said substrate can be a tube, a plate or a barrel-shaped vessel.

In the abovementioned heating structure, according to the present invention, the rough surface of the said barrel-shaped vessel can be provided at the outer surface, adjacent to a lower end, of the vessel or at a bottom of the vessel.

In the abovementioned heating structure, according to the present invention, the said rough surface can be a regular or irregular convex-concave surface.

In the abovementioned heating structure, according to the present invention, the roughness of the said rough surface is between 0.05 mm and 0.2 mm.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural schematic view of a conventional tube-shaped metal film heating structure.

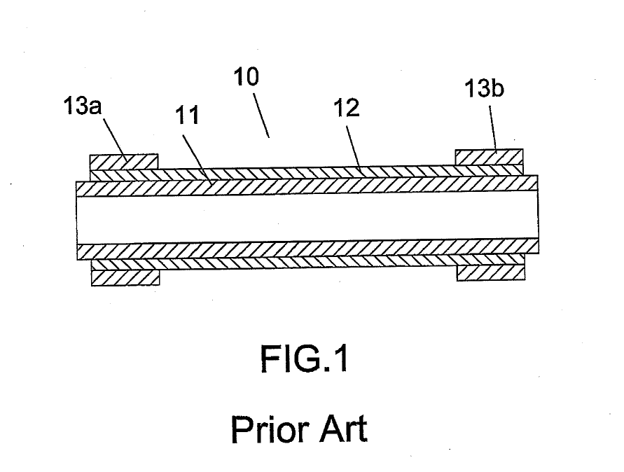

FIG. 2 shows a structural schematic view of a conventional plate-shaped metal film heating structure.

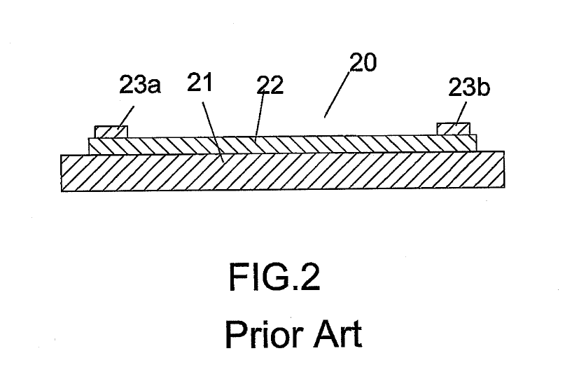

FIG. 3 shows a structural schematic view of a conventional tube-shaped carbon-material film heating structure.

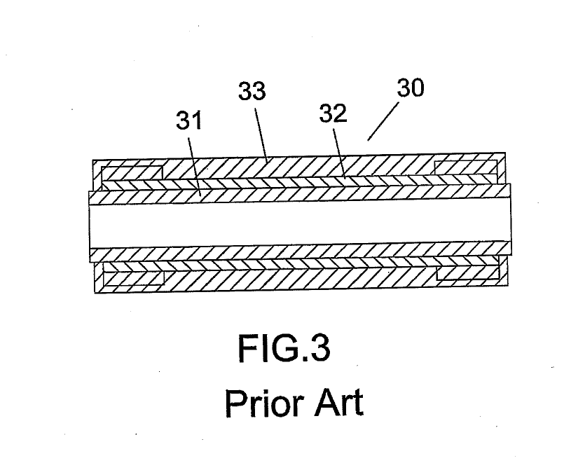

FIG. 4 shows a structural schematic view of a conventional plate-shaped carbon-material film heating structure.

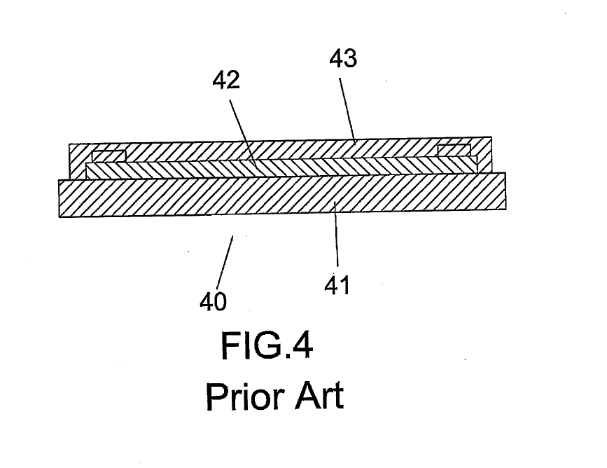

FIG. 5 shows a structural schematic view of a conventional tube-shaped carbon-material film heating structure.

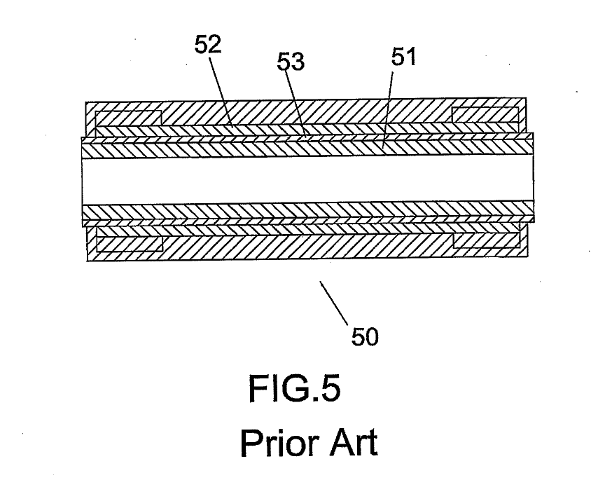

FIG. 6 shows a structural schematic view of a conventional plate-shaped carbon-material film heating structure.

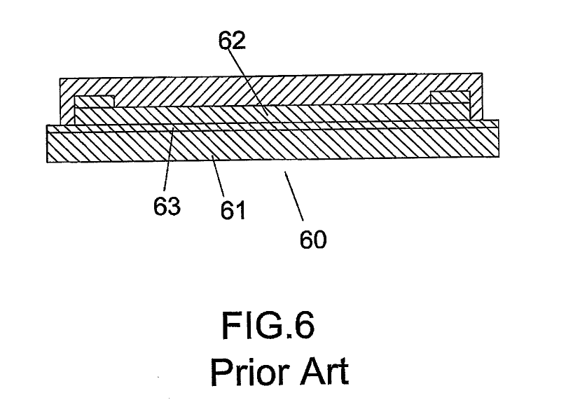

FIG. 7 shows a cutaway view of a tube-shaped heating structure of a first embodiment of the present invention.

FIG. 8 shows a cutaway view of a plate-shaped heatng structure of a first embodiment of the present invention.

FIG. 9 shows a cutaway view of a vessel heating structure of a first embodiment of the present invention.

### DETAILED DESCRIPTION OF THE PREFERRED EMBODIMENTS

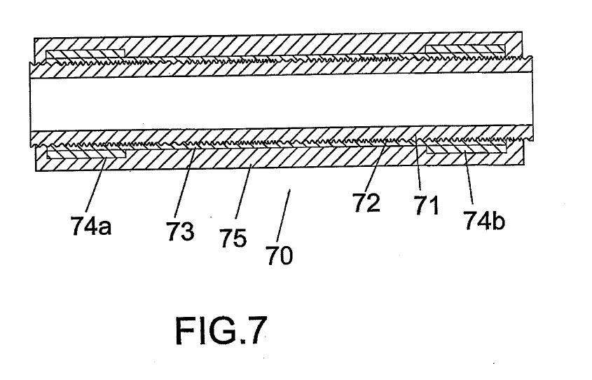

The present invention provides a heating structure which is primarily used to increase the heat transfer area and the adhesive force, for improving the heat transfer efficiency of the carbon-material film layer and at a same time, for preventing the carbon-material film layer from dropping out. The specific embodiment is referred to as in FIGS. 7 to 9.

FIG. 7 discloses a tube-shaped heating structure, wherein the said heating structure 70 is provided primarily with a tube-shaped substrate 71 of glass or a ceramic material. An outer surface of the tube-shaped substrate 71 is a rough surface 72 on which is coated with a carbon-material film layer 73. Two sides of the carbon-material film layer 73 are coated respectively with an electrode 74a, 74b to connect with a power cord; whereas, an insulation layer 75 is provided between the carbon-material film layer 73 and the two electrodes 74a, 74b to provide for insulation from electricity.

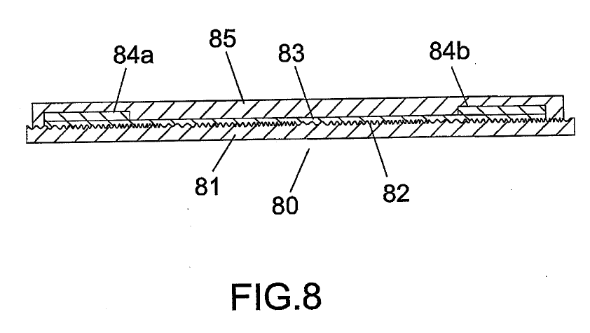

FIG. 8 discloses a plate-shaped heating structure, wherein the said heating structure 80 includes primarily a plate-shaped substrate 81 of glass or a ceramic material. An outer surface of the plate-shaped substrate 81 is a rough surface 82 on which is coated with a carbon-material film layer 83. Two sides of the carbon-material film layer 83 are coated respectively with an electrode 84a, 84b to connect with a power cord; whereas, an insulation layer 85 is provided between the carbon-material film layer 83 and the two electrodes 84a, 84b.

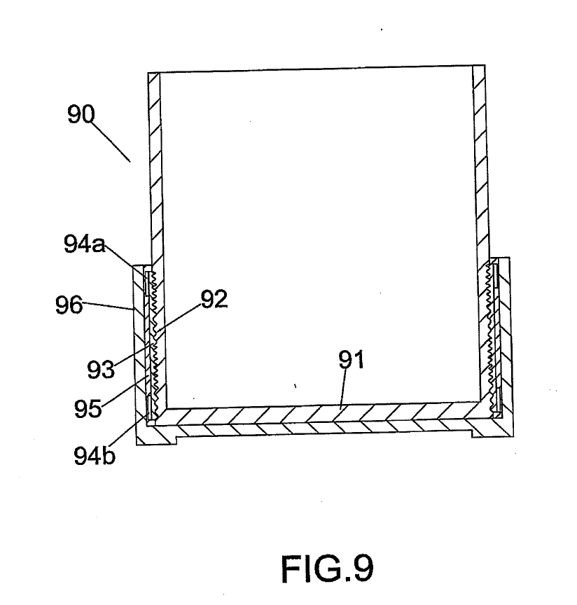

FIG. 9 discloses a barrel-shaped vessel heating structure, wherein the said heating structure 90 includes primarily a vessel substrate 91 of glass or a ceramic material. An outer surface of the substrate 91, adjacent to a lower end thereof, is provided with an annular-shaped rought surface 92 on which is coated with a carbon-material film layer 93. In addition, a top side and a bottom side of the carbon-material film layer 93 are coated respectively with an electrode 94a, 94b to connect with a power cord; whereas, an insulation layer 95 is provided between the carbon-material film layer 93 and the two electrodes 94a, 94b and an exterior of the insulation layer 95 is sheathed with a base 96 to provide for insulation from electricity and heat.

In implementation, the substrate 91 can be all kinds of water vessel, such as a tea cup, a teapot, a coffee pot, a thermos pot or a pan. On the other hand, the rough surface 92 on the substrate 91 can be provided at a bottom of the substrate 91.

In the heating structure of the present invention, the said substrate can be a tube, a plate or a barrel-shaped vessel, wherein the tube can be a glass tube, a quartz glass tube or a ceramic tube; the plate can be a glass plate or a ceramic plate; and the barrel-shaped vessel can be a tea cup, a teapot, a thermos cup, a thermos pot, a coffee pot, a hot pot or a stew pot.

Furthermore, in the heating structure of the present invention, the aforementioned carbon-material film layer is a carbon film layer or a graphite film layer.

To improve the heat transfer efficient and to increase the adhesive force of the film layer, in the abovementioned heating structure of the present invention, a side of the said substrate is formed with a rough surface by sand blasting using 80μ, to perform processing at about 0.15 mm. The said rough surface can be a regular or irregular convex-concave surface with the preferred roughness (Ra) between 0.05 mm and 0.2 mm, which can increase the heat transfer area between the substrate and the conductive film layer, thereby improving the heat transfer efficiency.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A heating structure comprising at least a substrate, a carbon-material film layer coated on a surface of the substrate and two electrodes provided at two sides of the carbon-material film layer, wherein a surface of the substrate coated with the carbon-material film layer is a rough surface for increasing a heat transfer area between the substrate and the carbon-material film layer, thereby improving a heat transfer efficiency and at a same time, increasing an adhesive force between the carbon-material film layer and the substrate to prevent the carbon-material film layer from dropping out.

2. The heating structure according to claim 1, wherein the substrate is a tube, a plate or a barrel-shaped vessel.

3. The heating structure according to claim 1, wherein the rough surface is a regular or irregular convex-concave surface.

4. The heating structure according to claim 1, wherein the roughness of the rough surface is between 0.05 mm and 0.2 mm.

5. The heating structure according to claim 2, wherein the rough surface of the barrel-shaped vessel is provided at an outer surface, adjacent to a lower end, of the vessel.
